(19) United States
(12) Patent Application Publication
(10) Pub. No.: US 2022/0050940 A1
(43) Pub. Date: Feb. 17, 2022

(54) METHOD AND SYSTEM FOR OPTIMIZING METAL STAMPING PROCESS PARAMETERS

(71) Applicant: METAL INDUSTRIES RESEARCH & DEVELOPMENT CENTRE, Kaohsiung (TW)

(72) Inventors: Ching-Hua HSIEH, Kaohsiung City (TW); Hui-Chi CHANG, Kaohsiung City (TW); Po-Tse SU, Taipei City (TW); Pin-Jyun CHEN, Kaohsiung City (TW); Fu-Chuan HSU, Kaohsiung City (TW)

(21) Appl. No.: 17/037,595

(22) Filed: Sep. 29, 2020

(30) Foreign Application Priority Data
Aug. 17, 2020 (TW) 109127965

(51) Int. Cl. G06F 30/20; G06F 30/17

(52) U.S. Cl. CPC G06F 30/20; G06F 2119/18; G06F 30/17

(57) ABSTRACT

Embodiments of the present disclosure provide a method and a system for optimizing metal stamping process parameters, thereby performing die parameters optimization and stamping forming curve optimization to achieve various design goals. Embodiments of the present disclosure automatically model the die parameters and stamping forming curves, and import them into an optimization process. Embodiments of the present disclosure use a response surface method to fit a linear polynomial function, and then perform optimization on a response surface to obtain a best die parameters values combination and a best stamping forming curve.

### RELATED APPLICATIONS

The present application is based on, and claims priority from Taiwan Application Serial Number 109127965, filed Aug. 17, 2020, the disclosure of which is hereby incorporated by reference herein in its entirety.

### BACKGROUND

### Field of Invention

The present disclosure relates to a method and a system for optimizing metal stamping process parameters. More particularly, the present invention relates to methods and systems for die parameters optimization and stamping forming curve optimization.

### Description of Related Art

In a stamping drawing process, geometrical profiles of dies (or molds) and stamping curves all affect the quality of formed workpieces. Conventional skills reply on experiences and instincts of technical personnel, or adopt trial and error methods to design die parameters and stamping curves. The conventional skills often take a lot of time and efforts, and thus cause significant increase of die design cost.

With the continuous advance of computer technology, the developments of computer-aided manufacture and computer-aided design, using the computer methodologies to resolve engineering problems, have become an industrial development trend. Another conventional skill uses a finite element method (FEM) in computer-aided engineering to analyze behaviors of a formed workpiece during stamping, so as to predict thickness changes, dimension changes and springback amounts of the formed workpiece during stamping as a reference basis for preliminary designs. However, such conventional skill still needs artificial judgements to adjust models, and thus also takes a lot of manpower cost.

### SUMMARY

An object of the present disclosure is to provide a method and a system for optimizing metal stamping process parameters for obtaining a set of optimal values of die parameters and an optimal stamping curve, thereby reducing blind spots of artificial judgements, thus decreasing the times and cost of die (mold) trials.

According to an aspect of the present invention, a method for optimizing metal stamping process parameters is provided. In the method, a die model and a workpiece model are built, in which the workpiece model is placed in the die model, the workpiece model having at least one quality item, each of the at least one quality item having a design goal. Then, a simulation operation is performed by using the die model and the workpiece model in accordance with a stamping curve. Thereafter, die parameters of the die model influencing the at least one quality item and numeric ranges of the die parameters are determined by collaborating the simulation operation with a full-factor design of experiments. Then, the simulation operation is repeated within the numeric ranges of the die parameters, thereby obtaining plural sets of sample data, in which each of the sets of sample data includes values of the die parameters and their corresponding values of the at least one quality item. Thereafter, a response surface fitting operation is performed on the sets of sample data, thereby obtaining a response surface. Then, an optimization operation is performed on the response surface with respect to the design goal by using an optimization algorithm, thereby obtaining a set of optimal values for the die parameters.

In some embodiments, the die parameters include an upper die angle, a lower die angle, and an upper die drawing depth, the at least one quality item including a formed workpiece thickness, the design goal including maximizing a uniformity of the formed workpiece thickness, or maximizing a minimum thickness of the formed workpiece thickness.

In some embodiments, the step of repeating the simulation operation within the numeric ranges of the die parameters is performed by using an automatic method.

According to another aspect of the present invention, a method for optimizing metal stamping process parameters. In the method, a die model and a workpiece model are built, in which the workpiece model is placed in the die model, the workpiece model having at least one quality item, each of the at least one quality item having a design goal. Then, plural stamping curves are defined. Thereafter, a simulation operation is performed by using the die model and the workpiece model in accordance with each of the stamping curves, thereby obtaining plural sets of sample data, in which the sets of sample data include the stamping curves and their corresponding values of the at least one quality item. Then, a response surface fitting operation is performed on the sets of sample data, thereby obtaining a response surface. Thereafter, an optimization operation is performed on the response surface with respect to the design goal by using an optimization algorithm, thereby obtaining an optimal stamping curve.

In some embodiments, the stamping curves include a blanking curve, a holding curve, a multiple pressing curve and/or a pulsation curve, the at least one quality item including a springback amount of a formed workpiece or a thinning rate of a formed workpiece, the design goal including a minimum value of the springback amount or a minimum range of the thinning rate.

In some embodiments, the step of defining the stamping curves and the simulation operation are performed by using an automatic method.

In some embodiments, the response surface fitting operation uses a sequential response surface method, and the optimization algorithm includes a genetic algorithm, an annealing algorithm, a hybrid algorithm, or a leapfrog algorithm.

According to another aspect of the present invention, a system for optimizing metal stamping process parameters is provided. The system is operated in a host computer, and includes a model-building module, a preprocessing module, a simulation module, a sample generation module, a response surface-fitting module, and an optimization module. The model-building module is configured to build a die model and a workpiece model, in which the workpiece model is placed in the die model, the workpiece model having at least one quality item, each of the at least one quality item having a design goal. The preprocessing module is configured to define at least one stamping curve. The simulation module is configured to perform a simulation operation repeatedly by using the die model and the workpiece model in accordance with one of the at least one stamping curve. The sample generation module is configured to repeat the simulation operation in accordance with each of the at least one stamping curve or within numeric ranges of die parameters of the die model influencing the at least one quality item, thereby obtaining plural sets of sample data, in which the sets of sample data include the stamping curves and their corresponding values of the at least one quality item, or each of the sets of sample data includes values of the die parameters and their corresponding values of the at least one quality item. The response surface-fitting module is configured to perform a response surface fitting operation on the sets of sample data, thereby obtaining a response surface. The optimization module is configured to perform an optimization operation on the response surface with respect to the design goal by using an optimization algorithm, thereby obtaining an optimal stamping curve or a set of optimal values for the die parameters.

In some embodiment, the system further includes a parameter-determining module that is configured to determine the die parameters and numeric ranges of the die parameters by collaborating the simulation operation with a full-factor design of experiments.

Hence, with the application of the embodiments of the present invention, optimal values of the die parameters and an optimal stamping curve can be obtained by optimization to reduce blind spots of artificial judgements, and thus the times and cost of die (mold) trials can be decreased.

### BRIEF DESCRIPTION OF THE DRAWINGS

The invention can be more fully understood by reading the following detailed description of the embodiment, with reference made to the accompanying drawings as follows:

FIG. 1 is a flow chart showing a method for optimizing metal stamping process parameters according to some embodiments of the disclosure;

FIG. 2A and FIG. 2B are schematic diagrams showing a die model and a workpiece model according to some embodiments of the disclosure;

FIG. 2C is a schematic diagram exemplarily showing die parameters according to some embodiments of the disclosure;

FIG. 3A is a schematic diagram exemplarily showing a stamping curve according to some embodiments of the disclosure;

FIG. 3B and FIG. 3C are schematic diagrams exemplarily showing an upper die angle and a lower die angle according to some embodiments of the disclosure;

FIG. 4 shows optimization results of formed workpiece thickness according to some embodiments of the disclosure;

FIG. 5 is a schematic block diagram showing a system for optimizing metal stamping process parameters according to some embodiments of the disclosure;

FIG. 6A is a flow chart showing a method for optimizing metal stamping process parameters according to other embodiments of the disclosure;

FIG. 6B to FIG. 6E are schematic diagrams exemplarily showing stamping curves according to other embodiments of the disclosure;

FIG. 6F is a schematic diagram for exemplarily explaining a springback amount of a formed workpiece according to other embodiments of the disclosure;

FIG. 7A to FIG. 7H are schematic diagrams for exemplarily explaining defining stamping curves according to other embodiments of the disclosure; and

FIG. 8 is a schematic block diagram showing a system for optimizing metal stamping process parameters according to other embodiments of the disclosure.

### DESCRIPTION OF THE PREFERRED EMBODIMENTS

Reference will now be made in detail to the embodiments of the present invention, examples of which are illustrated in the accompanying drawings. Wherever possible, the same reference numbers are used in the drawings and the description to refer to the same or like parts.

The terms such as “first” and “second” used in this discourse is merely for describing various elements, devices, operations, etc., but are not referred to particular order or sequence.

Embodiments of the present disclosure provide a method and a system for performing die parameters optimization and stamping forming curve optimization to achieve various design goals. Embodiments of the present disclosure automatically model the die parameters and stamping forming curves, and import them into an optimization process. Embodiments of the present disclosure use a response surface method to fit a linear polynomial function, and then perform optimization on a response surface to obtain a best die parameters combination and a best stamping forming curve.

Hereinafter, methods and systems for performing die parameters optimization according to embodiments of the present disclosure are explained.

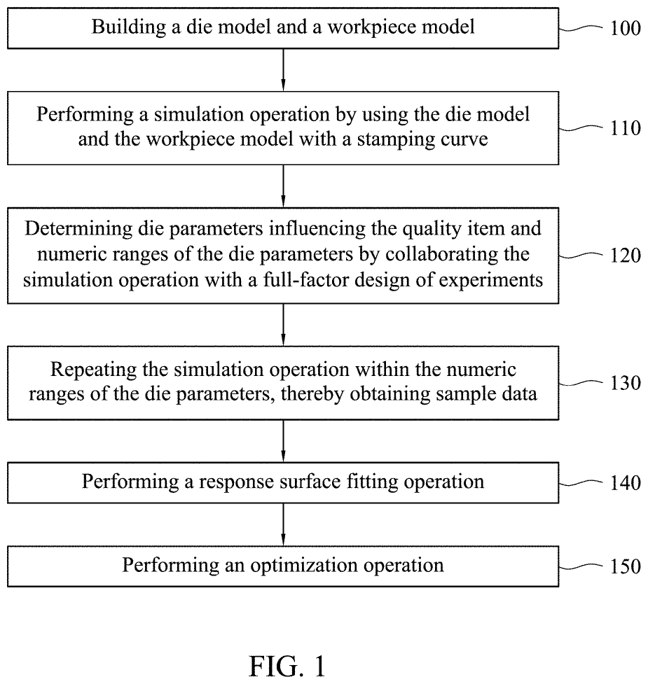

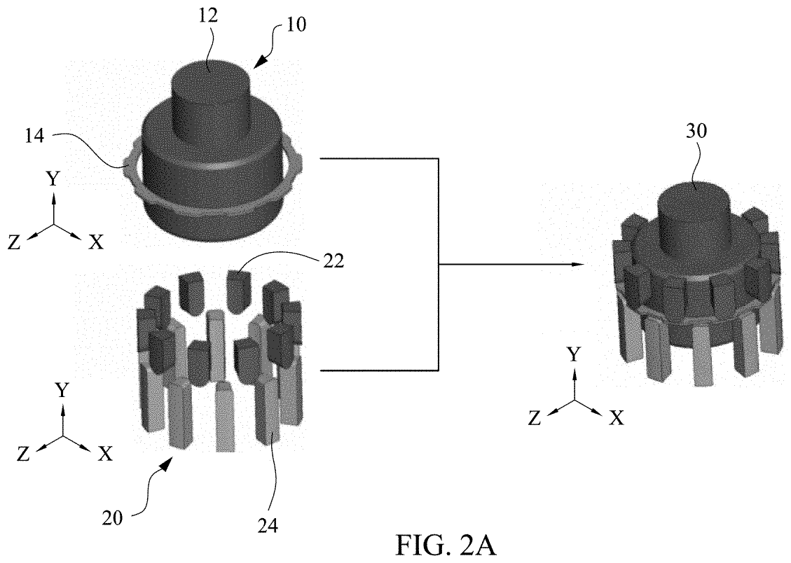

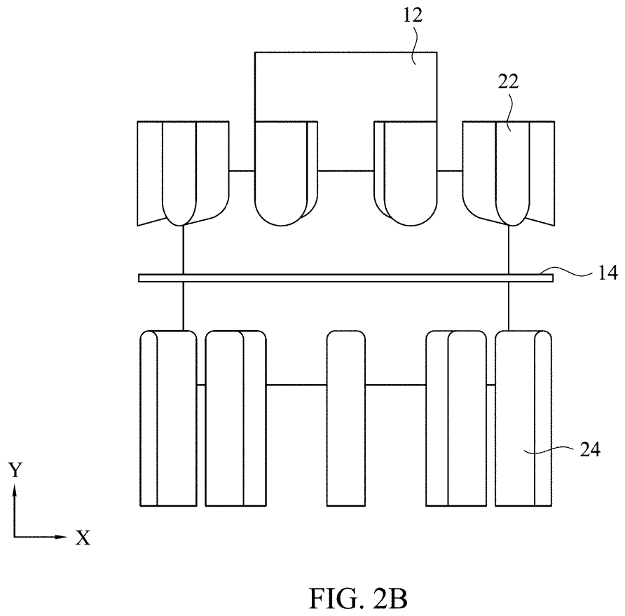

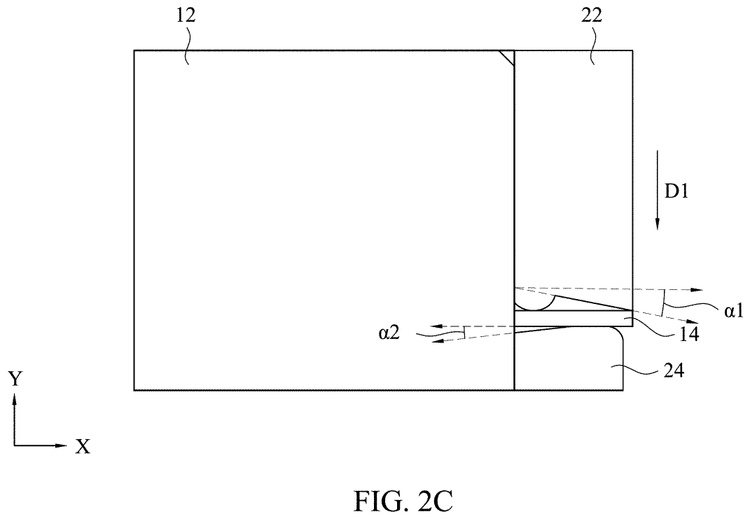

Referring to FIG. 1, FIG. 2A and FIG. 2B, FIG. 1 is a flow chart showing a method for optimizing metal stamping process parameters according to some embodiments of the disclosure, in which the metal stamping process parameters are die parameters; and FIG. 2A and FIG. 2B are schematic diagrams showing a die model 20 and a workpiece model 10 according to some embodiments of the disclosure. In this example, the die model 20 and the workpiece model 10 are used for forming a bearing retainer. It is noted that the die model 20 and the workpiece model 10 are used as an example for explanation. Embodiments of the present disclosure are suitable for use in the dies and workpieces of stamping processes used for forming any types of products, and thus are not limited thereto.

At first, step 100 is performed to build the die model 20 and the workpiece model 10, in which the workpiece model 10 is placed in the die model 20. The die model 20 includes an upper die (punch) 22 and a lower die 24, and the workpiece model 10 includes a guide punch 12 and a blank workpiece 14, in which the upper die (punch) 22, but is not rotatable; the blank workpiece 14 may freely move and rotate; and the lower die 24 and the guide punch 12 are fixed and cannot be moved and rotated. Embodiments of the present disclosure may use finite element software such as LS-DYNA or the like to build the workpiece model 10 and the die model 20. The workpiece model 10 has at least one quality item, such as a formed workpiece thickness. Each of the at least one quality item has a design goal, such as maximizing a uniformity of the formed workpiece thickness, or maximizing a minimum thickness of the formed workpiece thickness.

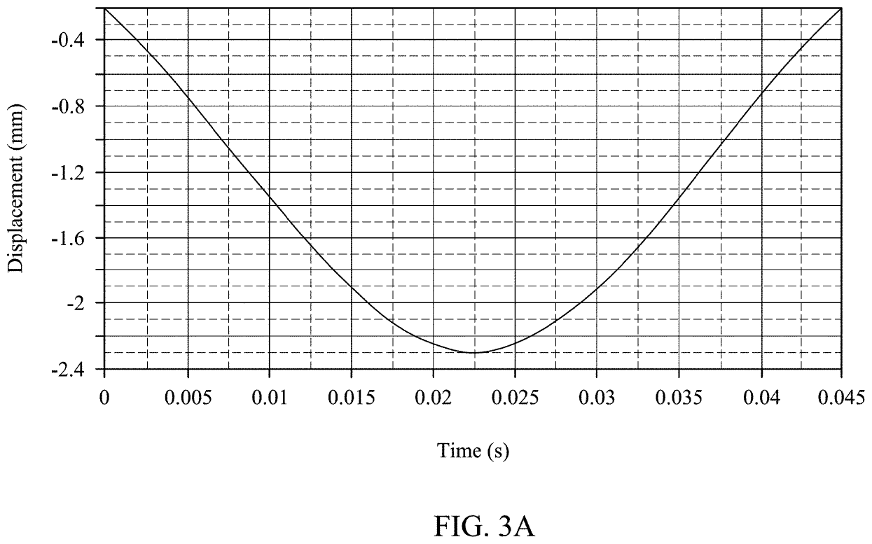

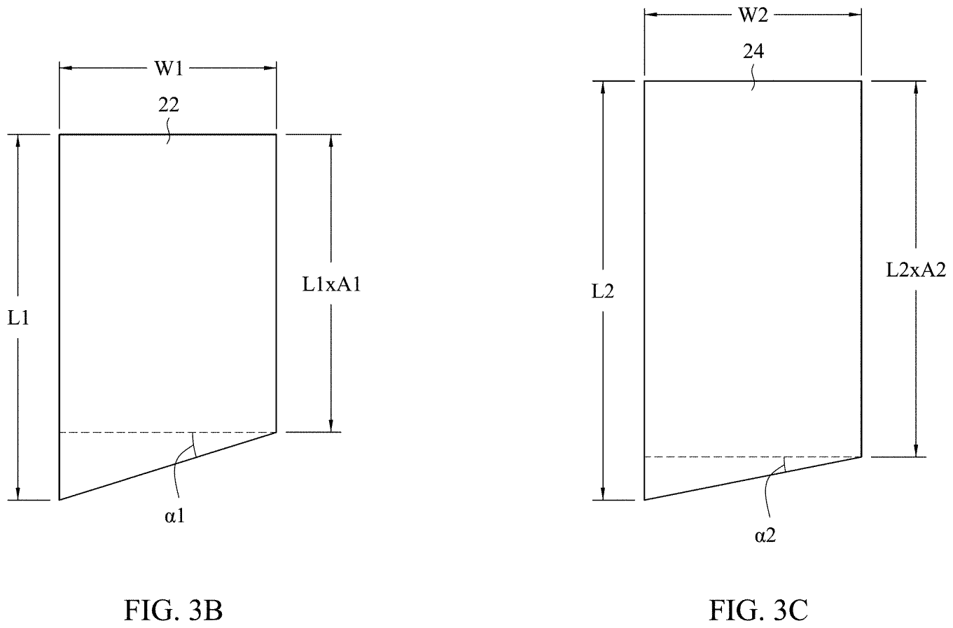

Then, step 110 performed to perform a simulation operation using the die model and the workpiece model in accordance with a stamping curve. Referring to FIG. 3A, FIG. 3A is a schematic diagram exemplarily showing a stamping curve according to some embodiments of the disclosure. Embodiments of the present disclosure may use, for example, a LS-DYNA card called BOUNDARY_PRESCRIBED_MOTION_RIGID to control a motion of a punch, in which motion modes regarding speed or displacements may be arbitrarily selected to control respective master/slave parts of the dies. Regarding the motion curve (i.e. the stamping curve) of the upper die (punch) 22, a LS-DYNA card called DEFINE_CURVE, for example, may be used to perform motion control, such as shown in FIG. 3A. To avoid wasting the running time from an upper dead point of the height of the die to the point contacting the blank workpiece, the stamping curve defined may start the simulation operation directly from the upper die (punch) 22 contacting the blank workpiece 14, thereby raising the analysis efficiency.

Thereafter, step 120 is performed to determine die parameters of the die model influencing the quality item and numeric ranges of the die parameters are determined by collaborating the simulation operation with a full-factor design of experiments. That is, the full-factor design of experiments basically considers all of the possible die parameters involved in the metal stamping process, and the simulation operation are repeated for the possible parameters with the fixed stamping curve, so as to determine the die parameters that influence the quality item. The utilization of the aforementioned full-factor design of experiments is well known to those who are skilled in the art, and is not described in detail herein. Referring to FIG. 2C, FIG. 2C is a schematic diagram exemplarily showing die parameters according to some embodiments of the disclosure. The die parameters that influence the at least one quality item may include an upper die angle α1, a lower die angle α2, and an upper die drawing depth D1. Certainly, embodiments of the present disclosure may include other die parameters that influence the quality item according to actual requirements.

Then, step 130 is performed to repeat the simulation operation within the numeric ranges of the die parameters, thereby obtaining plural sets of sample data, in which each of the sets of sample data includes values of the die parameters and their corresponding values of the at least one quality item. The numeric ranges of the upper die angle α1 defined in the embodiments of the present disclosure are from 5 degrees to 10 degrees; the numeric ranges of the lower die angle α2 defined in the embodiments of the present disclosure are from 0 degrees to 5 degrees; the and numeric ranges of the upper die drawing depth D1 defined in the embodiments of the present disclosure are from 1.6 mm degrees to 2.5 mm. Embodiments of the present disclosure may write LS-REPOST commands for programming the basic models built in the above and the die parameters defined in the above through an automatic method, in which the equations regarding the upper die angle α1 and the lower die angle α2 are:

$$\begin{matrix}tan α1 = \frac{( 1 - A 1 ) L 1}{W 1} & ( 1 ) \\ tan α2 = \frac{( 1 - A 2 ) L 2}{W 2} & ( 2 )\end{matrix}$$

Referring to FIG. 3B and FIG. 3C, FIG. 3B and FIG. 3C are schematic diagrams exemplarily showing an upper die angle and a lower die angle according to some embodiments of the disclosure, in which the upper die (punch) 22 has lengths L1 and L1×A1, and a width W1; and the lower die 24 has lengths L2 and L2×A2, and a width W2, wherein A1 and A2 are model scaling ratios inputted for adjusting the die angles. The embodiments of the present disclosure may perform a proportional scaling function between surfaces during the automatic model-building process, i.e. adjusting the model scaling ratios A1 and A2, so as to obtain different die model angles. Changes of the upper die drawing depth D1 do not affect the building process of the die model, and thus the upper die drawing depth D1 can be directly inputted. Advantageously, the aforementioned skill does not need to build respective models by artificially inputting the desired values of the die parameters one by one, thus greatly saving time.

Thereafter, step 140 is performed to perform a response surface fitting operation on the sets of sample data, thereby obtaining a response surface. Embodiments of the present disclosure may use, for example, a sequential response surface method to build metamodels, and uses area translating and scaling functions to find out an optimal area which is then iterated and converged to an expected result. Subsequently, an optimization algorithm is introduced and applied to the response surface generated from each iteration. Step 140 mainly defines proper parameters combinations in a design space, and distributes point under full-factor conditions, and generates a response surface metamodel by response to a simulation analysis of points, in which the number of the points determines the times of computation. If the degree of model fitting is smaller than 75%, the reliance level is low, and the experimental factors have to be readjusted. The sequential response surface method used in the embodiments of the present disclosure is well known to those who are skilled in the art, and thus are not described in detail herein.

Then, step 150 is performed to perform an optimization operation on the response surface obtained from step 140 with respect to the design goal (such as the uniformity and the minimum value of the formed workpiece thickness) by using an optimization algorithm, thereby obtaining a set of optimal values for the die parameters. Embodiments of the present disclosure perform area optimization by using the optimization strategy with the sequential response, in which each generated area generates an approximated response surface metamodel, and then an algorithm is applied for optimization, iteration and area-shrinking. The optimization algorithm used in the embodiments of the present disclosure includes a genetic algorithm, an annealing algorithm, a hybrid algorithm, or a leapfrog algorithm. The genetic algorithm, the annealing algorithm, the hybrid algorithm, and the leapfrog algorithm are well known to those who are skilled in the art, and are described in detail herein.

In sum, the method used in the embodiments of the present disclosure is mainly to introduce the die model into the simulation and optimization operations by using an automatic method. At first, a specific combination of values of design variables is selected in a design space, in which the points distribution is based on the design of experiments. Then, the aforementioned points selected by the design of experiments are used to perform simulation, so as to construct a response surface metamodel. Then, a strategy of sequential response surface method is applied to perform area-shrinking on the design space of the experiments, and a new response surface is generated after each iteration of area-shrinking. Thereafter, a hybrid algorithm is applied to the response surface to find out its optimal values. Each iteration is based on the optimal values obtained from the previous iteration, and the iteration step is repeated until convergence and stop. Through the aforementioned method, the precision of the metamodel can be increased, and the parameters values combination obtained can provide more reference value.

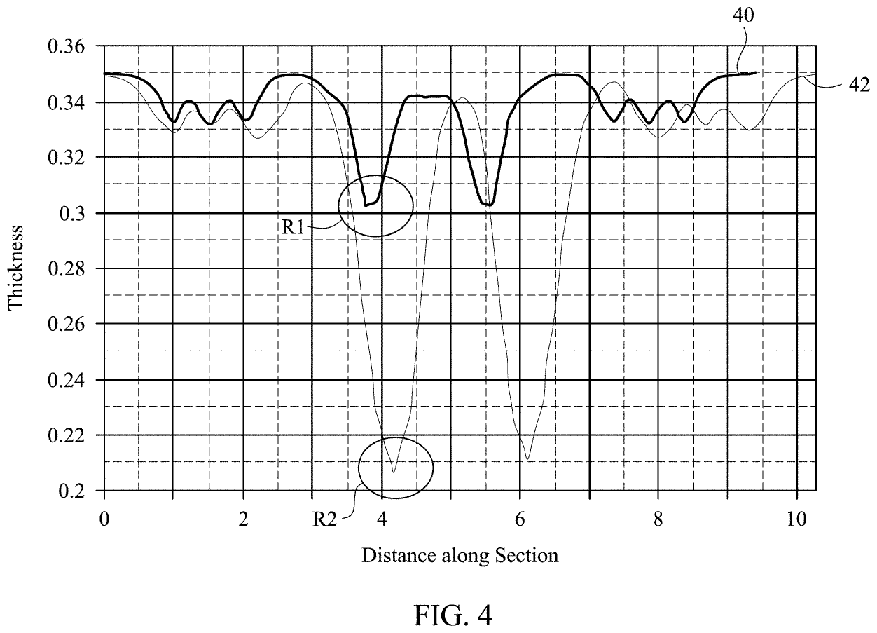

Referring to FIG. 4, FIG. 4 shows optimization results of formed workpiece thickness according to some embodiments of the disclosure. A curve 40 represents the formed workpiece thickness obtained after optimizing the upper die angle α1, the lower die angle α2, and the upper die drawing depth D1, in which al is 4.99 degrees, D1 is 1.66 mm and α2 is 5.05 degrees. A curve 42 represents the formed workpiece thickness obtained from the initial design of the upper die angle α1, the lower die angle α2, and the upper die drawing depth D1, in which al is 5 degrees, D1 is 2.27 mm and α2 is 9 degrees. As shown in FIG. 4, the R corners of the formed workpiece at sections R1 and R2 have the smallest thickness, in which the formed workpiece thickness at the section R2 of the curve 42 is 0.206 mm, the formed workpiece thickness at the section R1 of the curve 40 is 0.302 mm, and thus the embodiments of the present disclosure can greatly increase the thickness at the R corner of the formed workpiece. Meanwhile, it can be known from the thickness changes of the curves 40 and 42, the formed workpiece thickness obtained from the embodiments of the present disclosure has better uniformity.

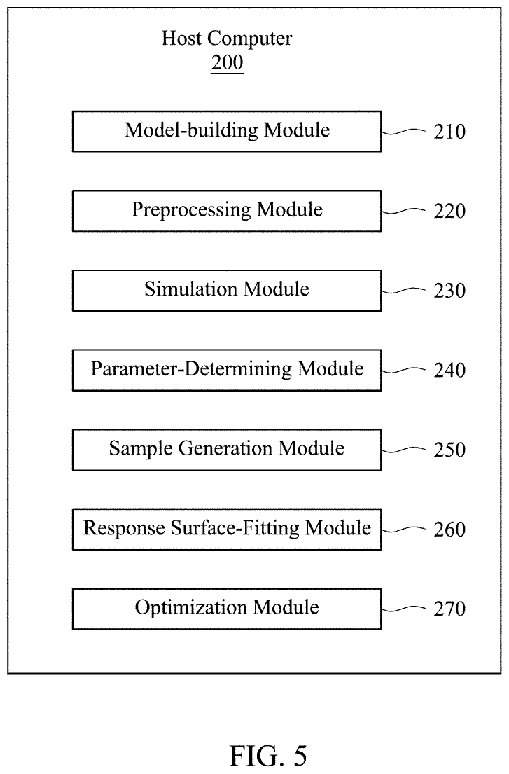

Embodiments of the present disclosure further provide a system for optimizing metal stamping process parameters to perform the aforementioned steps. Referring to FIG. 5, FIG. 5 is a schematic block diagram showing the system for optimizing metal stamping process parameters according to some embodiments of the disclosure, in which the metal stamping process parameters are die parameters. The system is operated in a host computer 200 including a processor and a memory, and software such as LS-DYN or the like is installed on the host computer 200. The system includes a model-building module 210, a preprocessing module 220, a simulation module 230, a parameter-determining module 240, a sample generation module 250, a response surface-fitting module 260, and an optimization module 270. The model-building module 210 is configured to build a die model and a workpiece model (step 100), in which the workpiece model is placed in the die model, the workpiece model 10 having at least one quality item, each of the at least one quality item having a design goal. The preprocessing module 220 is configured to define a stamping curve. The simulation module 230 is configured to perform a simulation operation by using the die model and the workpiece model in accordance with the stamping curve (step 110). The parameter-determining module 240 is configured to determine the die parameters and numeric ranges of the die parameters by collaborating the simulation operation with a full-factor design of experiments (step 120). The sample generation module 250 is configured to repeat the simulation operation within numeric ranges of die parameters of the die model influencing the at least one quality item (step 130), thereby obtaining plural sets of sample data, in which each of the sets of sample data includes values of the die parameters and their corresponding values of the at least one quality item. The response surface-fitting module 260 is configured to perform a response surface fitting operation on the sets of sample data (step 140), thereby obtaining a response surface. The optimization module 270 is configured to perform an optimization operation on the response surface with respect to the design goal by using an optimization algorithm (step 150), thereby obtaining a set of optimal values for the die parameters.

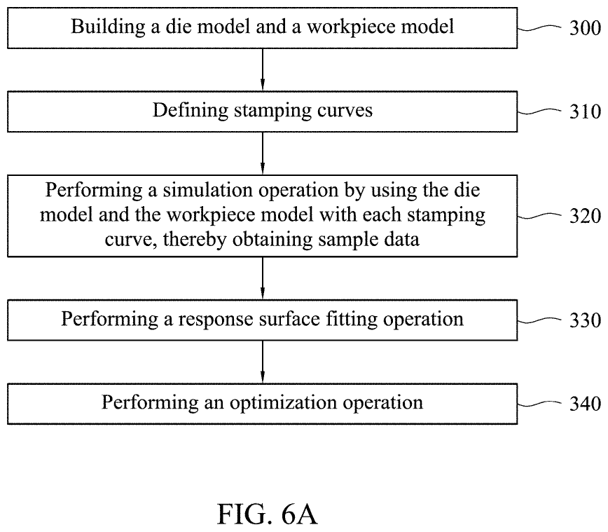

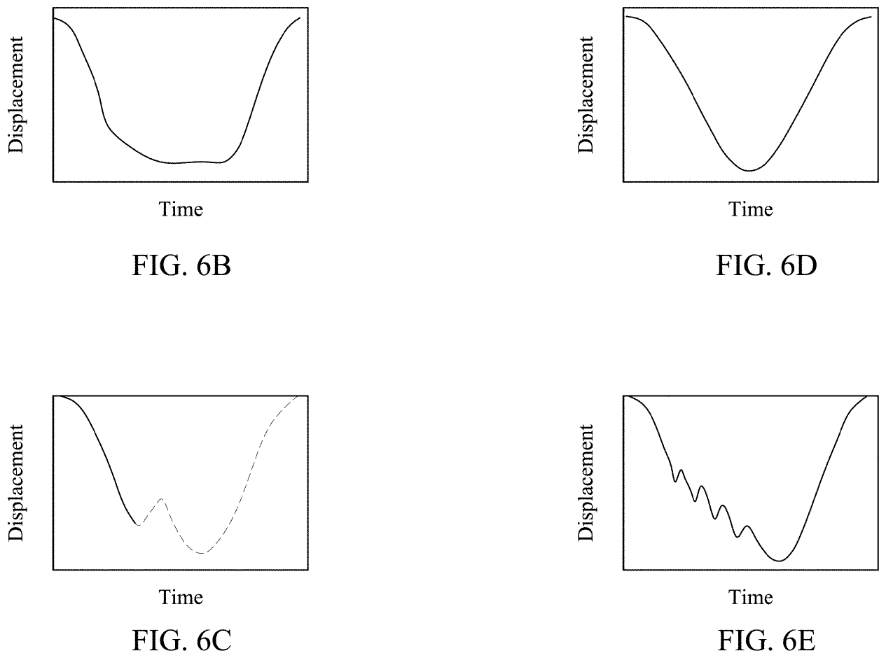

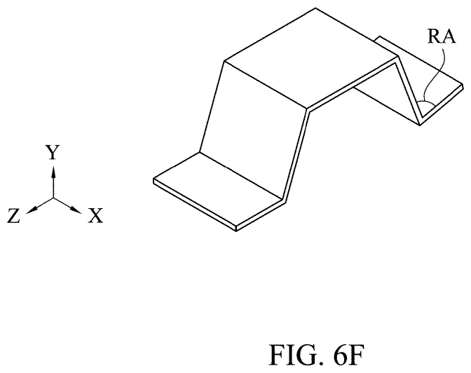

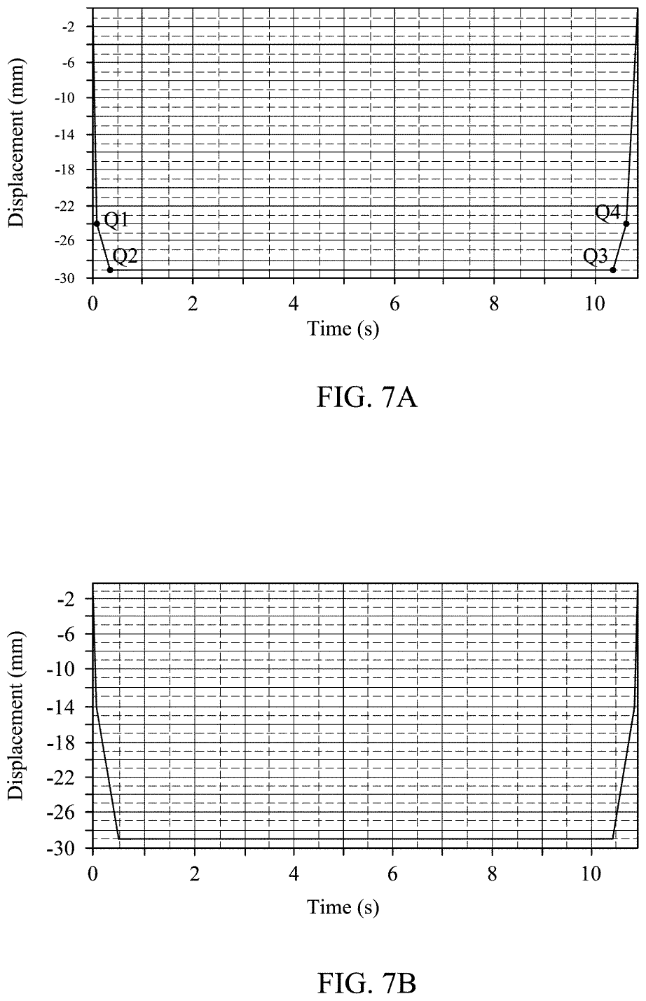

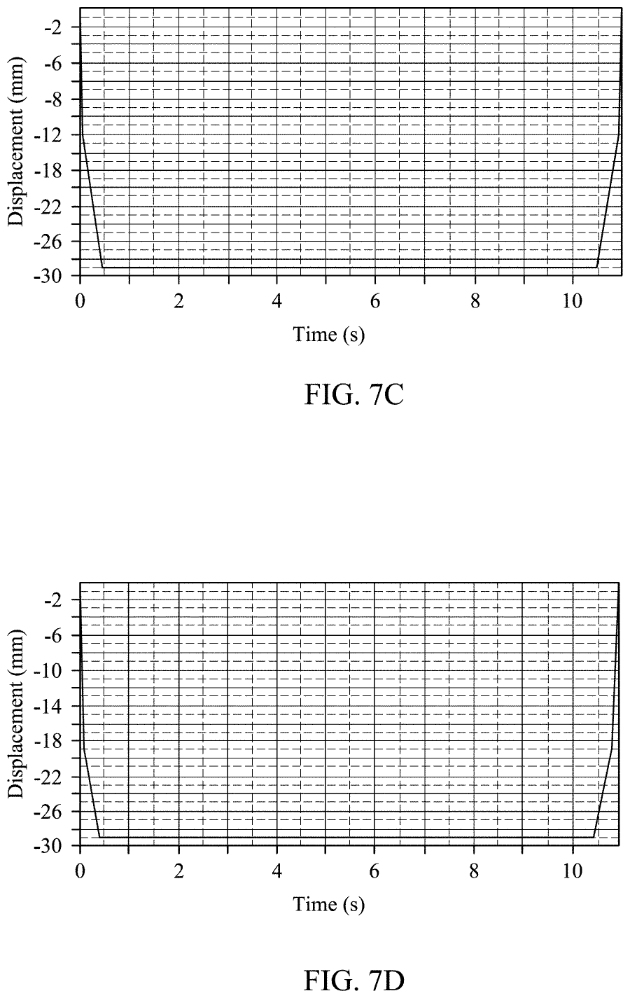

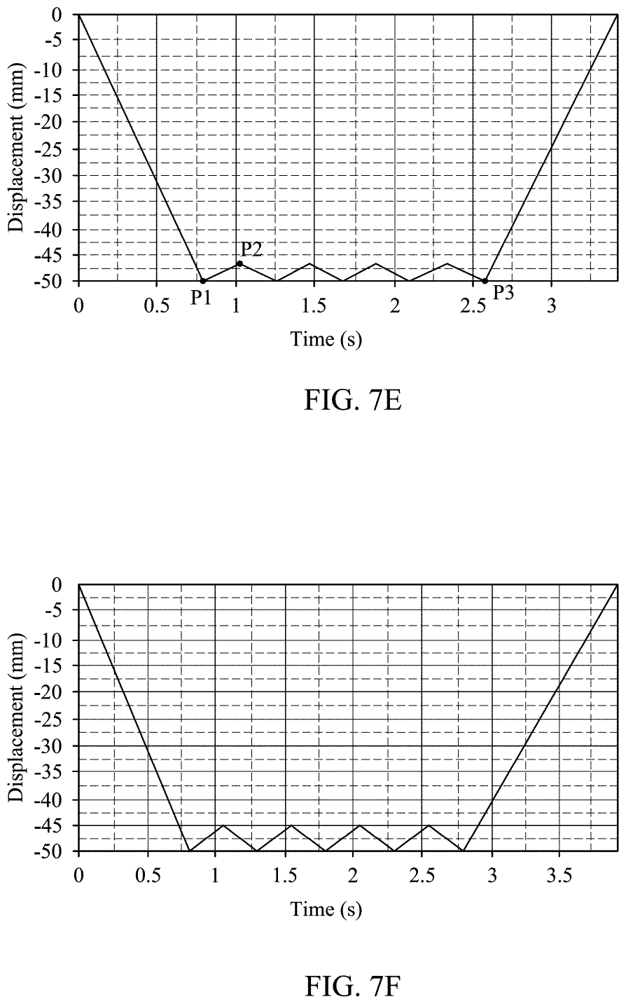

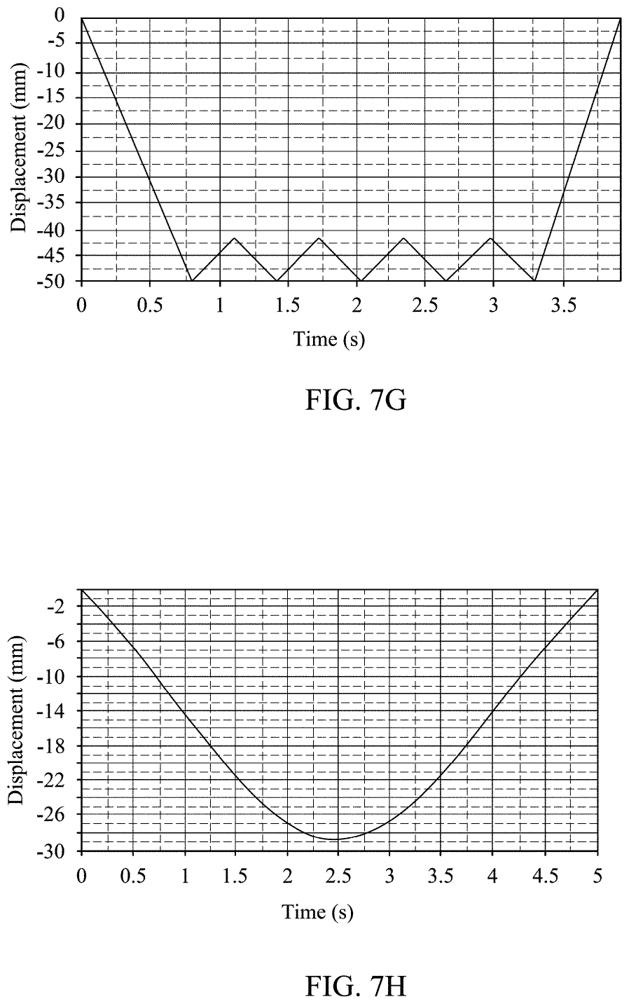

Hereinafter, a method and a system for optimizing metal stamping process parameters according to other embodiments of the present disclosure are described. Referring to FIG. 6A to FIG. 6F and FIG. 7A to FIG. 7H, FIG. 6A is a flow chart showing a method for optimizing metal stamping process parameters according to other embodiments of the disclosure, in which the metal stamping process parameters are a stamping curve; FIG. 6B to FIG. 6E are schematic diagrams exemplarily showing stamping curves according to other embodiments of the disclosure; FIG. 6F is a schematic diagram for exemplarily explaining a springback amount of a formed workpiece according to other embodiments of the disclosure; and FIG. 7A to FIG. 7H are schematic diagrams for exemplarily explaining defining stamping curves according to other embodiments of the disclosure.

In the method, at first, step 300 is performed to build the die model 20 and the workpiece model 10 as shown in FIG. 2A, in which the workpiece model 10 is placed in the die model 20. In this example, the die model 20 and the workpiece model 10 are used for testing the performance of a high-strength steel plate. The workpiece 10 model has at least one quality item, such as a springback amount of a formed workpiece (i.e. a change value of a springback angle RA of the high-strength steel plate shown in FIG. 6F), or a thinning rate of a formed workpiece. The design goal includes a minimum value of the springback amount of the formed workpiece (i.e. a minimum change value of the springback angle RA), or a minimum range of the thinning rate of the formed workpiece. Then, step 310 is performed to define plural stamping curves. The stamping curves include a blanking curve as shown in FIG. 6D, a holding curve as shown in FIG. 6B, a multiple pressing curve as shown in FIG. 6C and/or a pulsation curve as shown in FIG. 6E. Embodiments of the present disclosure may use an automatic method (a programming method) to adjust positions and slopes (speeds) of the punch in various stamping curves. For example, points Q1, Q2, Q3 and Q4 on a holding curve shown in FIG. 7A are adjusted to define respective holding curves shown in FIG. 7B to FIG. 7D; and points P1, P2 and P3 on a pulsation curve shown in FIG. 7E are adjusted to define respective pulsation curves shown in FIG. 7F to FIG. 7G. Besides, FIG. 7H is a blanking curve.

Thereafter, step 320 is performed to perform a simulation operation by using the die model 20 and the workpiece model 10 in accordance with each of the stamping curves (for example, shown in FIG. 7A to FIG. 7H), thereby obtaining plural sets of sample data, in which the sets of sample data include the stamping curves and their corresponding values of the at least one quality item. Then, step 330 is performed to perform a response surface fitting operation on the sets of sample data, thereby obtaining a response surface. Thereafter, step 340 is performed to perform an optimization operation on the response surface with respect to the design goal by using an optimization algorithm, thereby obtaining an optimal stamping curve. It is noted that step 330 is similar to step 140, and step 340 is similar to step 150, and thus steps 330 and 340 are described I detail again herein.

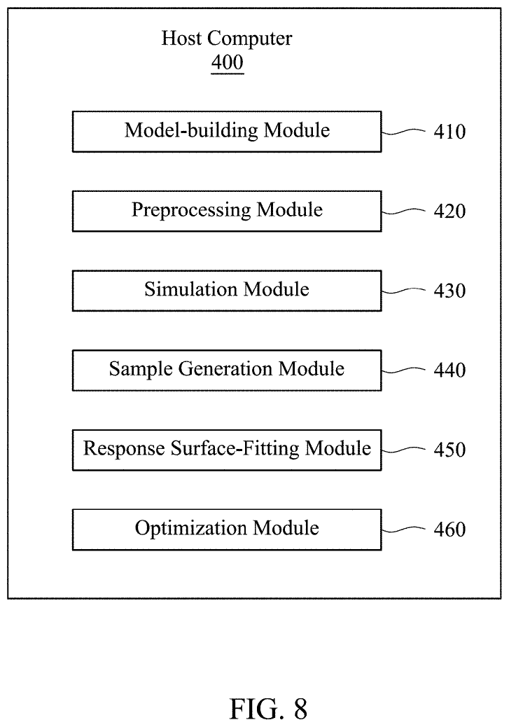

Embodiments of the present disclosure further provide a system for optimizing metal stamping process parameters to perform the aforementioned steps. Referring to FIG. 8, FIG. 8 is a schematic block diagram showing the system for optimizing metal stamping process parameters according to other embodiments of the disclosure, in which the metal stamping process parameters are stamping curves. The system is operated in a host computer 400 including a processor and a memory, and software such as LS-DYN or the like is installed on the host computer 400. The system includes a model-building module 410, a preprocessing module 420, a simulation module 430, a sample generation module 440, a response surface-fitting module 450, and an optimization module 460. The model-building module 410 is configured to build a die model and a workpiece model (step 300), in which the workpiece model is placed in the die model, the workpiece model having at least one quality item, each of the at least one quality item having a design goal. The preprocessing module 420 is configured to define plural stamping curves (step 310). The simulation module 430 is configured to perform a simulation operation using the die model and the workpiece model in accordance with one of the stamping curves. The sample generation module 440 is configured to repeat the simulation operation in accordance with each of the at least one stamping curve (step 320), thereby obtaining plural sets of sample data, in which the sets of sample data include the stamping curves and their corresponding values of the at least one quality item. The response surface-fitting module 450 is configured to perform a response surface fitting operation on the sets of sample data (step 330), thereby obtaining a response surface. The optimization module 460 is configured to perform an optimization operation on the response surface with respect to the design goal by using an optimization algorithm (step 340), thereby obtaining an optimal stamping curve.

It can be known from the above that, the application of the embodiments of the present disclosure can reduce blind spots of artificial judgements, and thus decrease the times and cost of die (mold) trials.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for optimizing metal stamping process parameters, the method comprising:
building a die model and a workpiece model, wherein the workpiece model is placed in the die model, the workpiece having at least one quality item, each of the at least one quality item having a design goal;
performing a simulation operation by using the die model and the workpiece model in accordance with a stamping curve;
determining a plurality of die parameters of the die model influencing the at least one quality item and numeric ranges of the die parameters by collaborating the simulation operation with a full-factor design of experiments;
repeating the simulation operation within the numeric ranges of the die parameters, thereby obtaining a plurality of sets of sample data, wherein each of the sets of sample data comprises values of the die parameters and their corresponding values of the at least one quality item;
performing a response surface fitting operation on the sets of sample data, thereby obtaining a response surface; and
performing an optimization operation on the response surface with respect to the design goal by using an optimization algorithm, thereby obtaining a set of optimal values for the die parameters.

2. The method of claim 1, wherein the die parameters comprise an upper die angle, a lower die angle, and an upper die drawing depth, the at least one quality item comprising a formed workpiece thickness, the design goal comprising maximizing a uniformity of the formed workpiece thickness, or maximizing a minimum thickness of the formed workpiece thickness.

3. The method of claim 1, wherein repeating the simulation operation within the numeric ranges of the die parameters is performed by using an automatic method.

4. The method of claim 1, wherein the response surface fitting operation uses a sequential response surface method, and the optimization algorithm comprises a genetic algorithm, an annealing algorithm, a hybrid algorithm, or a leapfrog algorithm.

5. A method for optimizing metal stamping process parameters, the method comprising:
building a die model and a workpiece model, wherein the workpiece model is placed in the die model, the workpiece model having at least one quality item, each of the at least one quality item having a design goal;
defining a plurality of stamping curves;
performing a simulation operation by using the die model and the workpiece model in accordance with each of the stamping curves, thereby obtaining a plurality of sets of sample data, wherein the sets of sample data comprise the stamping curves and their corresponding values of the at least one quality item;
performing a response surface fitting operation on the sets of sample data, thereby obtaining a response surface; and
performing an optimization operation on the response surface with respect to the design goal by using an optimization algorithm, thereby obtaining an optimal stamping curve.

6. The method of claim 5, wherein the stamping curves comprise a blanking curve, a holding curve, a multiple pressing curve and/or a pulsation curve, the at least one quality item comprising a springback amount of a formed workpiece or a thinning rate of a formed workpiece, the design goal comprising a minimum value of the springback amount or a minimum range of the thinning rate.

7. The method of claim 5, wherein defining the stamping curves, and the simulation operation are performed by using an automatic method.

8. The method of claim 5, wherein the response surface fitting operation uses a sequential response surface method, and the optimization algorithm comprises a genetic algorithm, an annealing algorithm, a hybrid algorithm, or a leapfrog algorithm.

9. A system for optimizing metal stamping process parameters, wherein the system is operated in a host computer, and comprises:
a model-building module configured to build a die model and a workpiece model, wherein the workpiece model is placed in the die model, the workpiece model having at least one quality item, each of the at least one quality item having a design goal;
a preprocessing module configured to define at least one stamping curve;
a simulation module configured to perform a simulation operation repeatedly by using the die model and the workpiece model in accordance with one of the at least one stamping curve;
a sample generation module configured to repeat the simulation operation in accordance with each of the at least one stamping curve or within numeric ranges of a plurality of die parameters of the die model influencing the at least one quality item, thereby obtaining a plurality of sets of sample data, wherein the sets of sample data comprise the stamping curves and their corresponding values of the at least one quality item, or each of the sets of sample data comprises values of the die parameters and their corresponding values of the at least one quality item;
a response surface-fitting module configured to perform a response surface fitting operation on the sets of sample data, thereby obtaining a response surface; and
an optimization module configured to perform an optimization operation on the response surface with respect to the design goal by using an optimization algorithm, thereby obtaining an optimal stamping curve or a set of optimal values for the die parameters.

10. The system of claim 9, further comprising:
a parameter-determining module configured to determine the die parameters and numeric ranges of the die parameters by collaborating the simulation operation with a full-factor design of experiments.

11. The system of claim 9, wherein the stamping curves comprise a blanking curve, a holding curve, a multiple pressing curve and/or a pulsation curve, the at least one quality item comprising a springback amount of a formed workpiece or a thinning rate of a formed workpiece, the design goal comprising a minimum value of the springback amount or a minimum range of the thinning rate.

12. The system of claim 9, wherein the die parameters comprises an upper die angle, a lower die angle, and an upper die drawing depth, the at least one quality item comprising a formed workpiece thickness, the design goal comprising maximizing a uniformity of the formed workpiece thickness, or maximizing a minimum thickness of the formed workpiece thickness.

13. The system of claim 9, wherein the response surface fitting operation uses a sequential response surface method, and the optimization algorithm comprises a genetic algorithm, an annealing algorithm, a hybrid algorithm, or a leapfrog algorithm.
